(19) United States
(12) Patent Application Publication
(10) Pub. No.: US 2011/0054926 A1
(43) Pub. Date: Mar. 3, 2011

(54) Medical Health Care System

(76) Inventor: George C. Yang, San Bruno, CA (US)

(21) Appl. No.: 12/553,941

(22) Filed: Sep. 3, 2009

(51) Int. Cl. G06Q 50/00

(52) U.S. Cl. 705/2

(57) ABSTRACT

A system for management of public health care where participating entities consume and purchasing health care services. Entities contribute to a health care fund and insurance account, both managed and supported by government. Personal physicians enroll participating entities until a maximum enrollment is reached, and the physicians are compensated from the fund per enrollment, the physicians see enrolled entities and recommend medications/treatments. Wellness maintenance providers enroll participating entities until maximum enrollment is reached, providing preventive medical services to entities, and compensated from the fund per enrollee. WMPs pay all costs of medications prescribed by physicians, WMPs pay 80% for recommended treatments. Pharmacies accept prescription orders from physicians and dispense directly to participating entities or their WMPs, receiving payment from the WMPs. Curative and specialty service providers provide treatments and services recommended by physicians, CSSPs paid by WMPs and insurance on a 80/20 split.

### FIELD OF THE INVENTION

This invention relates to public health care and insurance systems, and more specifically, an improved public medical health system focusing on cost effectiveness, preventive measures and general public's well being.

### BACKGROUND OF THE INVENTION

The health and medical care industry is one of the biggest industries in the US, and is worth billions of dollars. According to the US Census Bureau, the percentage of people in the US without health insurance was 15.3 percent in 2007 and the number of uninsured was 45.7 million. With the aggressive push for universal health care of the current Obama presidency, it is imperative to develop a more cost effective, patient oriented and streamlined health care system.

With billions of dollars at stake, there have been observations that pharmaceutical companies strive to design medications to “contain” an ailment, instead of finding a cure, and fewer companies have been going into the vaccine business. Then there are also those who seek to defraud the healthcare system, like a doctor in south Texas who replaced perfectly good teeth in poor children just to claim money from Medicaid.

The public health care includes but is not limited to Medicare, Medicaid, Veterans Health Administration, Military Health System/TRICARE, Indian Health Service, State Children's Health Insurance Program (SCHIP), and Federal Employees Health Benefits Program. The private health care system includes insurance companies such as Blue Cross/Blue Shield, and other Preferred provider organizations (PPOs) and Health maintenance organizations (HMO), etc.

FIG. 1A (prior art) describes one of the most common existing health care models 90. As shown in FIG. 1A, insurance buyers' and/or tax money is injected into the PPO and Government Health Care Fund periodically. Money from these sources in addition to insured patients' co-payments will be paid out to independent service providers on a pay per service basis. The PPO has the main objective to control and reduce payment to ISPs by measures such as rigid price control, high co-payment or delay or denial of service. To attain more money from the funds and co-payments, ISPs seek to provide services could be beyond actual need. There are also potential problems such as:

Rigid price control discourage new ISPs

ISP and patients conspire to commit fraud again PPO

FIG. 1B (prior art) describes another one of the most common existing health care models 92. As shown in FIG. 1B, insurance buyers' and/or tax moneys are injected into the HMO and Government Health Care Fund periodically. Money from these, in addition to insured patients' co-payments, will be paid out to subsidiary service providers and/or public medical facilities. HMO has the main objective to control cost by limiting capital investment, imposing high co-payment, adopting complex process, or delay or denial of services.

There are also potential problems such as:

Inadequate service capacity and service quality

Patients are not given full range of treatment options

Patients avoid system unless/until conditions become serious

### ADVANTAGES AND SUMMARY OF THE INVENTION

The present invention is an improved medical health care system that focuses on preventive services over curative treatment, cost efficiency, patient choice and free market operations.

The present invention is an improved health care system designed to develop a system with professionals who have a financial incentive to keeps subscribers happy, healthy and productive and not just an incentive to sell subscribers services to make higher profits.

The objective of the present invention is to encourage the use of preventive services before serious conditions develops, to create a group of professionals whose sole financial interest is the patients' health and well being, to create a group of market players whose will work hard for preventive and curative solutions in order to contain health care cost, to create a vibrant market of all types of treatments and services and to minimize government intervention in the application of medicine.

The medical health care system of the present invention calls for a unified plan within which each consumer will need to make three independent yet interconnected decisions. These decisions are rooted in the principles of free market. Each consumer will be able to choose the provider best suited to their unique needs. Each provider can tailor their services to target general or specific niche markets to attract customers. It also takes a lesson from the US constitution. Each choice consists of a group of private sector professionals designed to check and balance the influence and power of another group of private sector operators. Most importantly, these choices foster a matrix that steers the financial incentive decidedly in favor of prevention instead of treatment, cure instead of containment.

One advantage and object of the present invention is to provide universal access of health care without excessive bureaucracy and inconvenience to consumers.

Another advantage and object of the present invention is to provide community pooling of risk in a competitive health care market with input by consumers.

Yet another advantage and object of the present invention is to provide a foreseeable and predictable public health care budget and manage those budget by encouragement of preventive and curative medicine.

Another advantage and object of the present invention is to provide a large number of professionals who's own financial interest has a direct link to the general public's health and well being.

Further details, objects and advantages of the present invention will become apparent through the following descriptions, and will be included and incorporated herein.

### BRIEF DESCRIPTION OF THE DRAWINGS

FIG. 1A (prior art) is a flowchart describing one of the most common existing health care models 90.

FIG. 1B (prior art) is a flowchart describing another one of the most common existing health care models 92.

FIG. 2A is a representative flowchart showing the medical health care system 100 of the present invention in the perspective of cash flow.

FIG. 2B is a representative flowchart showing the medical health care system 100 of the present invention in the perspective of consumer choices.

FIG. 3 is a chart illustrating the supply and demand relationship between WMPs 106 and CSSPs 110.

FIG. 4 illustrates how medical health care system 100 of the present invention works in three different demands from insured consumers 102.

FIG. 5 describes the approval process of new services and drugs.

FIG. 6 describes a fast track process for new service and drug approval.

FIG. 7 illustrates optional measures to further strengthen the medical health care system 100.

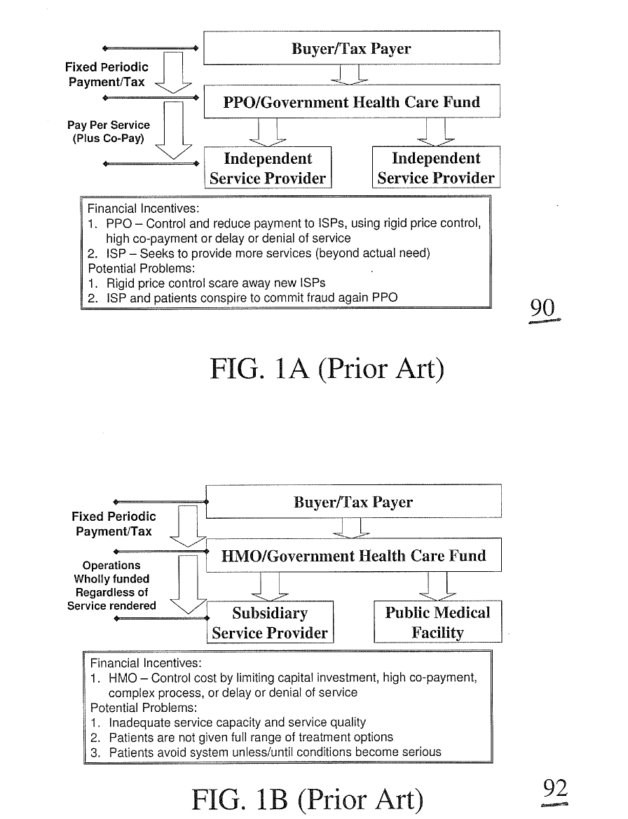

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

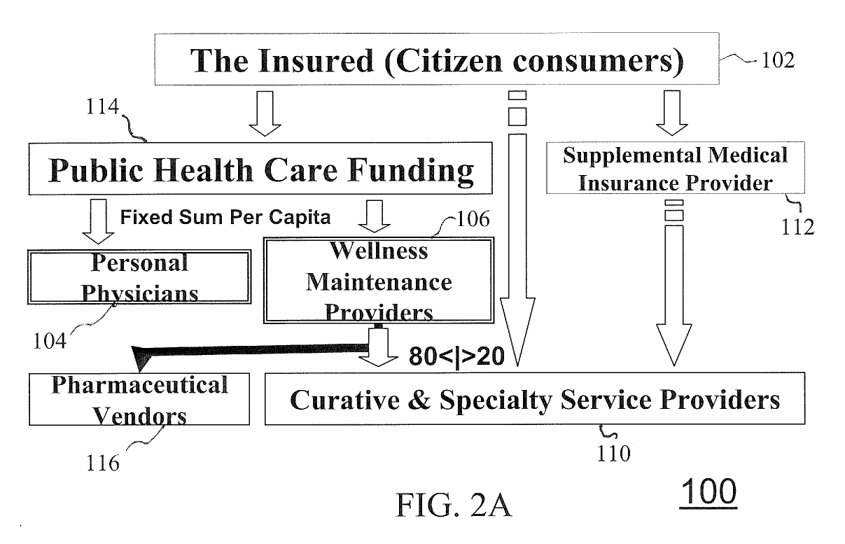

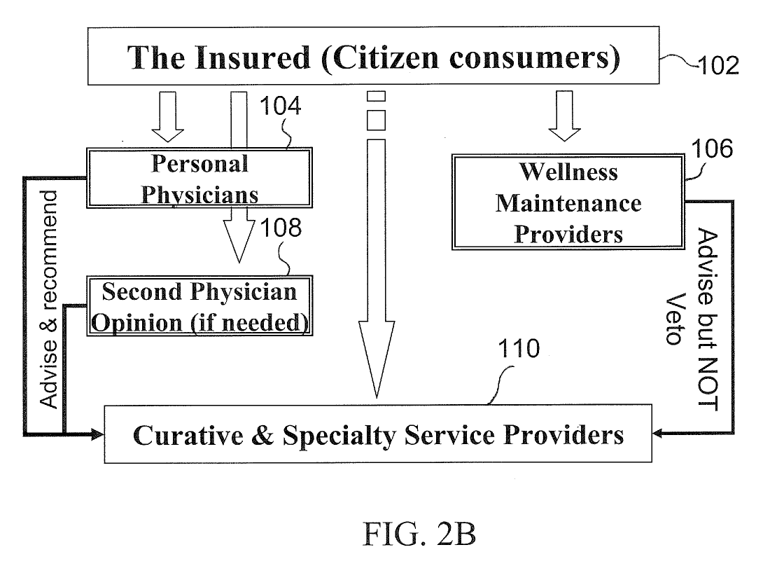

FIG. 2A is a representative flowchart showing the medical health care system 100 of the present invention in the perspective of cash flow. As shown in FIG. 2A, the medical health care system 100 consists essentially of insured consumers 102, public health care funding 114, supplemental medical insurance provider (SMIP) 112, personal physicians 104, Wellness Maintenance Providers (WMP) 106, pharmaceutical vendors 116 and Curative and Specialty Service Providers (CSSP) 110.

As shown in FIG. 2A, insured consumers 102 will pay their insurance premium periodically to the public health care funding 114 in which the federal and state governments will also provide funding. And from the public health care funding 114, money will be paid to personal physicians 104 and Wellness Maintenance Providers (WMPs) 106, solely based on the number of enrollment they have and a fixed amount is paid for each enrollment. The purpose of fixed WMP 106 payment is to create market vibrancy with competition and WMP's 106 competitive in global capital market. The payment rate is adjusted every 5 years base on the P/E ratio of the most profitable WMP 106 in that period. Periodic adjustments are however limited to a fix percentage point to avoid destabilizing the market and scaring off potential investors. Also, newly introduced treatments should come with reasonable corresponding raise to WMP 106.

The core of the present medical health care system 100 is the creation of WMP 106. The WMP 106 keeps overall health care cost down by encouraging the use of preventive services before serious conditions develops among insured consumers 102.

WMP 106, in short, is a place designed where a healthy insured consumer 102 go to stay healthy, hence lower the health care cost by prevention of more serious diseases. WMP 106 builds wellness centers in the community, where healthy insured consumers 102 come regularly for preventive treatments such as vaccinations, body check up, etc. without fear of getting infected by people who may have contagious diseases. Upon requests or pre-arrangement, WMP 106 may even provide services directly at insured consumers' 102 home. WMP 106 may contract out services such as dental, medical testing, and addiction treatment and it may provide additional psychological counseling and preventive screening. Since WMPs 106 are funded by public health care funding 114, they must accept all applicants and are forbidden to adopt geographical skimming by enforcing geographic pairing.

The operation of WMPs 106 is completely funded by public health care funding 114 by receiving fixed payment from government per patient 102 enrollment and its only source of income is the fixed payment from member enrollment (insured consumers 102). Any form of cash back for enrollment is strictly forbidden. Advertising & sales budget per WMP 106 is limited and not linked to the number of enrollment of individual WMPs 106.

WMPs 106 must provide recurring care (Wellness Care) as defined by the Public health authority. They pay for 80% of the cost of emergency or specialty care (i.e. curative actions) and necessary medication. With those measures in place, WMPs 106 have high incentive to seek curative measures instead of depending on chronic medicines. WMPs 106 also do not have the veto power for treatment, meaning they cannot deny or delay treatment when personal physicians 104 and patients (insured consumers) 102 agree on particular treatments. WMPs 106 must also provide unhindered information for personal physicians 104 of insured consumers 102 and provide accurate aggregate enrollment/health status data to the public in order to help them select their WMPs 106.

As shown in FIG. 2A, WMPs 106 will pay for 80% of the entire cost of treatment of each enrolled insured consumer 102 to CSSPs 110 and the entire cost prescription to pharmaceutical vendors 116. To become financially competitive, WMPs 106 must increase the number of enrollment while keeping its expenses down. Since they cannot deny treatment requests from members 102 through their personal physicians 114, it is to their benefits to keep the insured members 102 healthy to minimize curative costs. In so doing, preventive measures are provided to insured consumers 102 to prevent more serious conditions from developing. WMPs 106 also compete for enrollment with each other with extra treatment options, better performance, or/and improved service quality and they may also target niche markets with enhanced services. They may also form consortium to negotiate pharmaceutical pricing (group pricing) to reduce costs. WMPs 106 could also limit executive pay package to a reasonable level to stay competitive.

The objective of fixed payments to personal physicians 104 is to give a newly starting physician a reasonable income and an established physician a respectable income in their community. The calculation is based on a reasonable number of patients 102 a physician 104 might have and also on community income and living expenses where the physicians 104 are located. For example, in rural areas, a base stipend should be considered for physicians 104 willing to locate there. Since the only income for each personal physician 114 is from the fixed payments paid based on member 102 enrollment and the number of enrollment for each physician 114 is fixed, the only way to maximize income is to have the maximum enrollment allowed and keep them for as long as they could by keeping them healthy. Personal physicians 114, unless the enrollment cap is reached, are not allowed to turn away patients 102. Also by focusing on preventive measures, they can limit efforts/time spent on each insured consumer 102. Any form of cash back as reward for enrollment is strictly forbidden and advertising/promotion budget is again limited and the same amongst physicians 114. In short, there is a huge incentive for personal physician 114 to provide quality, cost effective, preventive treatments so they recruit as many as possible enrollments and keep them as healthy and as long as they could.

It is imperative to ensure that personal physicians 104 recommendations for or against any service or treatment gets them any financial gain/loss to keep those decisions as neutral and patient oriented as possible. They are not allowed to accept financial incentive from WMPs 106, CSSPs 110 and pharmaceutical vendors 116 for recommending for or against certain treatment and brands of medication prescribed. They are, however, able to order any testing and those tests will be paid by WMPs 106. Personal physicians 104 may organize into clinics with multiple practicing physicians 104 so new physicians can get insured consumers 102 and establish physicians can have a balance work load. They can even refer patients 102 to other physicians 104 with expertise with revenue sharing agreement.

There are three types of prescription medication provided by the pharmaceutical vendors 116 under the system:

### Type A—Vital Medication:

Such as vaccine or drugs for internal organ illness

Fully paid for by WMPs 106

### Type B—Elective Medication:

Medicines that alleviates non-fatal conditions such as for cold or dermatological ailments

Small fixed out of pocket cost

### Type C—Optional Medication:

Such as ED medications or supplements

Supply by WMPs 106 at cost: wholesale+relevant cost

Individual WMPs 106 may choose to cover them

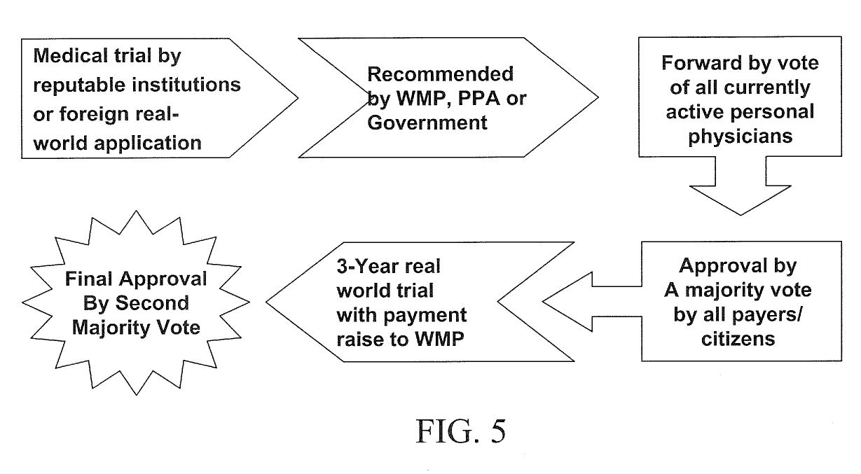

FIG. 5 describes the approval process of new services and drugs. Firstly, medical trial is conducted by reputable institutions or foreign real-world application and then the new service and drug must be recommended by WMPs 106, Personal Physician Association (PPA) or Government. It is followed by a vote of all currently active personal physicians 104. Then it should be approved by a majority vote by all insured consumers 102. A 3-Year real world trial with payment raise to WMPs 106 would be conducted. The final step is the final approval by a second majority vote.

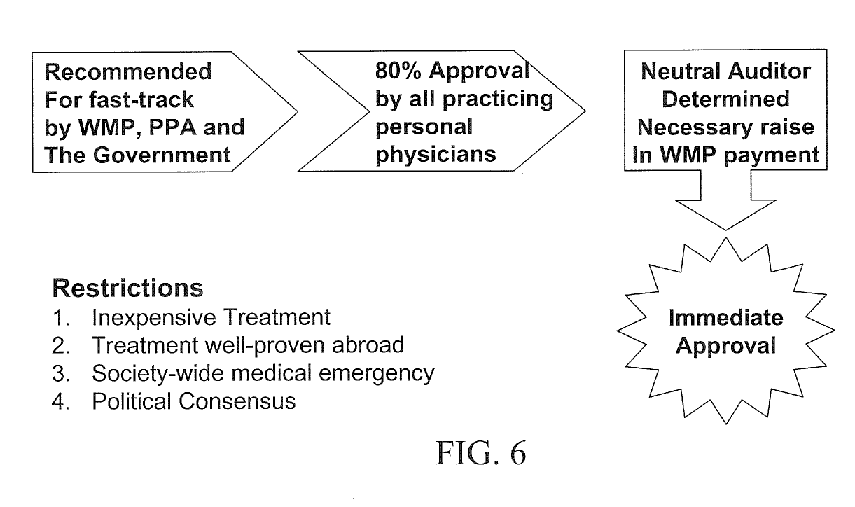

FIG. 6 describes a fast track process for new service and drug approval. Proposed services and drugs are recommended by WMPs 106, PPA and the government. The approval should be confirmed by a over 80% vote by all practicing personal physicians 104. A neutral auditor is then brought in to determine whether WMP 106 payment should be adjusted. However, fast track approval should be restricted to urgent situations and to inexpensive treatment, treatment well-proven abroad, to those related to society-wide medical emergency and political consensus.

CSSPs provide treatment services to insured consumers 102 when such services are requested by consumers 102 and/or their personal physicians 104. As best shown in FIG. 2A, services provided by CSSPs 110 are paid for by WMPs 106 and SMIPs 112 at a 80/20 split. The selection of particular CSSPs 110 is determined by the free market where WMPs 106 will make the decisions based on service quality, level of technology, reputation, and/or cost. Since rules governing free markets apply, price fixing and monopoly is unlikely to happen. There will be no hard price cap and modular growth can quickly meet gaps in treatment and supply.

SMIPs 112 account for 20% of all CSSPs 110 charges. As shown in FIG. 2A, in the medical health care system 100 of the present invention, on top of the public health care funding 114 every insured consumer 102 also pays a percentage of income into an individual SMIP 112 account until the total amount paid on account reaches a preset balance. The payment must be compulsory to avoid skimming. Money in every SMIP 112 account earns interest. When a medical cost arises, SMIP 112 pays CSSPs 110 and deducts that amount from individual account. When an account reaches zero, the individual pays up to annual deductible set by government. Any cost beyond that is paid by SMIP 112 without affecting any other individual accounts and to ensure CSSPs 110 always get compensated. At death, the account balance will be refunded to the designated heir untaxed.

In the case of families, every family pays a percentage of income into an individual SMIP 112 account until account reaches the preset balance. The payment must be compulsory to avoid skimming. Money in every SMIP 112 account earns interest. When a medical cost arises, SMIP 112 pays CSSPs 110 and deducts that amount from individual family account. When an account reaches zero, the family pays up to annual deductible set by the federal government. Any cost beyond that is paid by SMIP 112 without affecting any other individual account and to ensure CSSPs 110 always gets paid. When the account grows to twice the preset balance amount, additional interest will be refunded to families.

Every 3 years, US government offers a hidden bid to choose one provider, in an effort to avoid collusion, based on interest rate, for example Prime+1%, and SMIP 112 will pay all funded accounts that interest rate. SMIPs 112 makes profit by investing the money from funded accounts at a rate higher than the agreed upon rate which is adequate to cover medical costs to CSSPs 110 from other accounts with zero balance. Optionally, SMIPs 112 may audit any WMP and CSSP for fraud. These measures help SMIP 112 to be profitable for a financial institution to undertake the task of the operations.

FIG. 2B is a representative flowchart showing the medical health care system 100 of the present invention in the perspective of decision making and interaction. Each insured consumer 102 will need to make three independent yet interconnected decisions. The first decision is the most intimate decision of them all, the selection of a personal physician 104. In the present invention 100, consumers 102 can see their personal physicians 104 anytime without a co-payment for the visit as their personal physicians 104 are compensated as described above. This arrangement would permit even those consumers who are in tight financial situations to see his/her doctor regularly. For relatively less severe problems, this arrangement would allow office visits before they develop into major health issues. In the medical health care system 100, personal physicians 104 are independent operators who are compensated based on how many subscribed patients they manage to enroll. Keeping their patients happy and healthy means the doctor 104 has more time for other subscribed users 102 and more time for referrals. Insured consumers 102, in certain cases, would be allowed to seek a second opinion from a different personal physician 104′.

The second decision is to pick a WMP 106 which determines how services, tests, treatments are selected, as well as medication one required for general health and well being. The system 100 will provide insured consumers 102 with a professional shopper, WMPs 106, whose main duty is to acquire the services necessary and requested by insured consumers 102 and their personal physicians 104. WMPs 106, like personal physicians 104, are paid a fixed amount based on number of subscribers 102 and with that money they pay 80% of the cost of treatment to CSSPs 110. Unlike the HMO system we have today, WMPs 106 cannot veto or otherwise delay treatment agreed upon between insured consumer 102, their physicians 104 and CS SPs 110. Still, WMPs 106 have quite a number of ways to keep down the cost, hence to increase profit, such as keeping their subscribers 102 healthy, negotiating down the price of curative treatments and medication, looking for cheaper alternatives and preventing fraud.

The third decision is to select CSSPs 110. As discussed, the market for curative treatment should be completely unencumbered and free of anti-competitive price fixing. CSSPs 110 should be allowed to charge what ever the market will bear. The idea is that medical treatment is not a commodity. Higher quality doctors, i.e., those with more experience, those with better track-records, those who practice using newer and more effective treatments, etc., should be able to command higher prices. It benefits all to encourage doctors to achieve more and practice at higher levels in their respective fields of practice. Insured consumers 102 will pay 20% out of their own pocket through SMIP 110 payment which will help keep the decision rational. WMPs 106 may try to convince consumers 102 with more economical options to maintain financially strong as they are paying 80% of the cost. However, as shown in FIG. 2B, they can only provide advice and have no power to veto or delay treatment or to dictate provider selection. In addition, the SMIP 110 contribution provides impetus that will motivate consumers 102 to stay healthy.

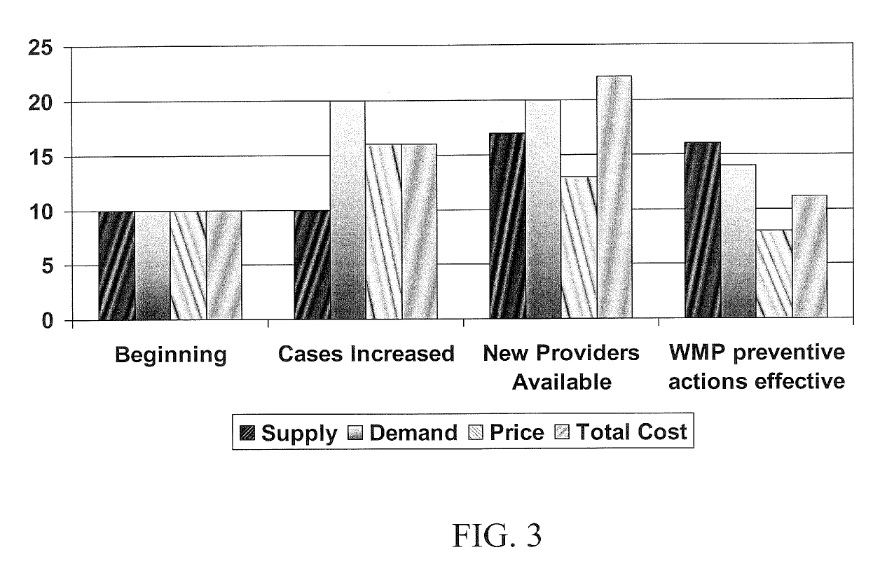

FIG. 3 is a chart illustrating the supply and demand relationship between WMPs 106 and CSSPs 110. As shown in FIG. 3, new cases put pressure existing supply and drive demand, price and total cost up. Due to the high demand, new CSSPs 110 will enter the market to make prices more competitive. As the market settles down, supply and demand are more in balance as both prices and total costs decrease to an optimal level.

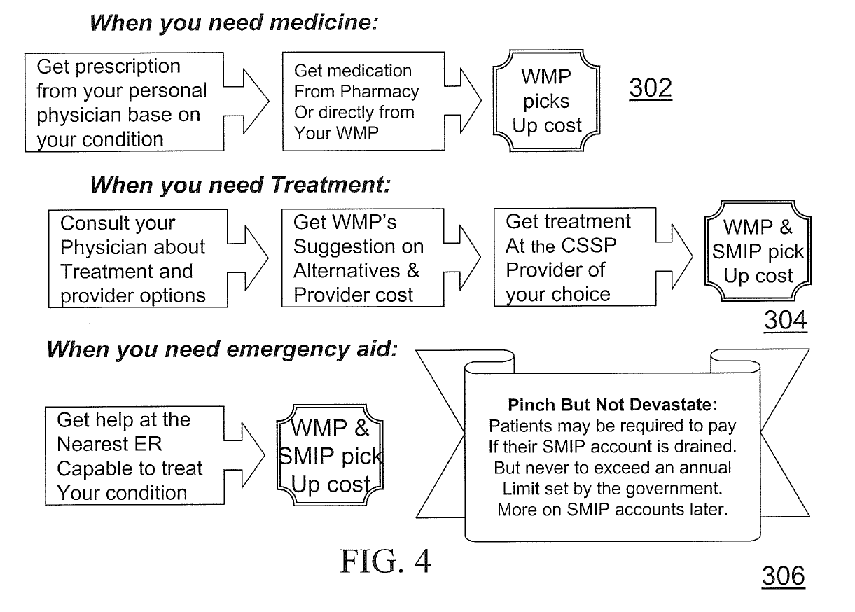

FIG. 4 illustrates how the medical health care system 100 of the present invention works in three different need situations of insured consumers 102. As shown in FIG. 4, in the situation where prescriptive medication is required, the process 302 starts when a personal physician 104 issues prescription base on the consumer's medical condition. Insured consumers 102 will then get their prescription for free either at WMP 106 or pharmaceutical vendor 116. WMP 106 will then pay the cost at full to pharmacy 116.

As shown in FIG. 4, in the situation where medical treatment may be needed, process 304 starts when insured consumers 102 go to their personal physicians 104 on account of their medical conditions. Patients 102 and their doctor 104 will then discuss and determine possible treatments and options for CSSPs 110. Patients 102 will then get a Personal Physicians' 104 suggestion on CSSPs 110 costs, performance and quality. Patients 102 will then make a final decision with or without their personal physicians' 104 input and/or second opinion. Selected CS SPs 110 will then provide the treatment and WMP 106 and SMIP 112 will then pay CSSPs 110 according to the 80/20 split.

Also shown in FIG. 4, in the case of a medical emergency, process 306 starts when urgent medical help is required by an insured consumer 102. Insured consumers 102 will be sent to the nearest ER capable of treating patients' 102 condition. WMP 106 and SMIP 112 will then pay the ER, which is likely also a CSSP 112, according to the 80/20 split.

In this system, short term savings come primarily from two sources. Firstly, encouragement of prevention of diseases at all levels through financial incentives. Secondly, group bargaining power of the WMPs' 106 will keep the cost of treatment, medication and recurring services down. Long term savings will come when the focus has been shifted from the containment of ailments to the cure of them. The exact savings are hard to be defined. This, after all, will be a system consisting of individuals with their own free wills and entrepreneurial spirit.

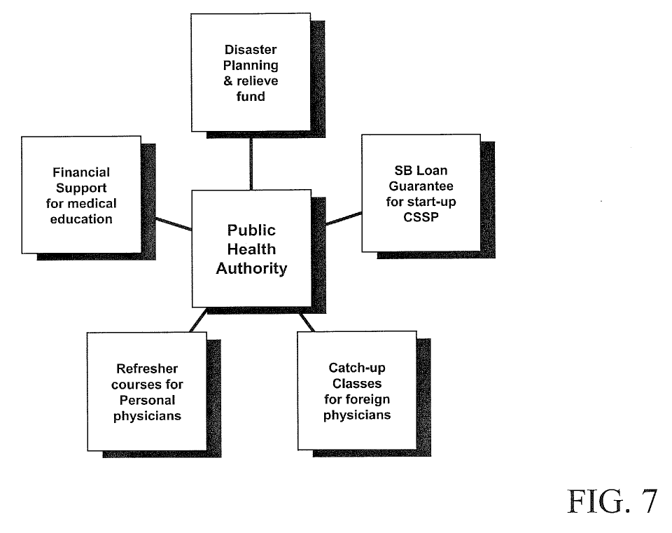

FIG. 7 illustrates optional measures to further strengthen the medical health care system 100. The measures include a disaster planning and relief fund, small business loan guarantee for start up CSSPs 110, catch-up classes for foreign physicians, refresher courses for personal physicians 104 and financial support for special and continuing medical education.

Other optional additions to the medical health care system 100 includes multiple SMIPs 110, which will guard against bank failure, using account pairing, and interest averaging for individual accounts. Multiple physician accreditation agencies will encourage the most effective way of meeting physician 104 demand. Government may also demand services from citizens in lieu of payments, such as periodic blood donation and organ transplant waivers.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A system for public health care management, the system comprising:
participating entities for consuming and purchasing health care services, the participating entities contributing financially and periodically to a central health care fund and a health insurance account, the central health care fund and the health insurance account both managed and financially supported by the federal, state or other local or remote government;
personal physicians for accepting enrollments of participating entities until a maximum enrollment cap is reached, the personal physicians being compensated financially directly from the central health care fund on a fixed amount per enrollment basis, and the personal physicians further seeing the enrolled participating entities and recommending medications and/or treatments as required;
wellness maintenance providers (WMPs) for accepting enrollments of participating entities until a maximum enrollment cap is reached, the WMPs providing preventive medical services to enrolled participating entities, the WMPs being compensated financially directly from the central health care fund on a fixed amount per enrollment basis, the WMPs paying in full the cost of the medications prescribed by the personal physicians, and the WMPs paying a predetermined percentage of the cost of the treatments recommended by the personal physicians;
pharmacies for accepting prescription orders from the personal physicians and dispatching the medications directly to the participating entities or their WMPs, the pharmacies receiving payment in full for their products from the WMPs; and
curative and specialty service providers (CSSPs) for providing all sorts of medical treatments and services recommended by the personal physicians for their participating entities, the CSSPs being paid in full by both WMPs and the health insurance account according to a predetermined percentage basis split.

2. The system for public health care management of claim 1, wherein the participating entities comprise individual adults and families.

3. The system for public health care management of claim 1, wherein the WMPs are not allowed to decline enrollment requests from the participating entities unless the maximum enrollment cap is reached.

4. The system for public health care management of claim 1, wherein the personal physicians are not allowed to decline enrollment requests from the participating entities unless the maximum enrollment cap is reached.

5. The system for public health care management of claim 1, wherein the WMPs pay about 80±10% of the cost of treatments recommended by the personal physicians and the predetermined percentage basis split of payments to CSSPs by WMPs and the health insurance account is between about 80±20% and about 20±20%, respectively.

6. The system for public health care management of claim 1, wherein the WMPs pay about 80% of the cost of treatments recommended by the personal physicians and the predetermined percentage basis split of payments to CSSPs by WMPs and the health insurance account is between about 80% and about 20%, respectively.

7. An improved method for management of a public health care system, the method comprising the following steps:
Providing participating entities for consuming and purchasing health care services, the participating entities contributing financially and periodically to a central health care fund and a health insurance account, the central health care fund and the health insurance account both managed and financially supported by the federal, state or other local or remote government;
Providing personal physicians for accepting enrollments of participating entities until a maximum enrollment cap is reached, the personal physicians being compensated financially directly from the central health care fund on a fixed amount per enrollment basis, and the personal physicians further seeing the enrolled participating entities and recommending medications and/or treatments as required;
Providing wellness maintenance providers (WMPs) for accepting enrollments of participating entities until a maximum enrollment cap is reached, the WMPs providing preventive medical services to enrolled participating entities, the WMPs being compensated financially directly from the central health care fund on a fixed amount per enrollment basis, the WMPs paying in full the cost of the medications prescribed by the personal physicians, and the WMPs paying a predetermined percentage of the cost of the treatments recommended by the personal physicians;
Providing pharmacies for accepting prescription orders from the personal physicians and dispatching the medications directly to the participating entities or their WMPs, the pharmacies receiving payment in full for their products from the WMPs; and
Providing curative and specialty service providers (CSSPs) for providing all sorts of medical treatments and services recommended by the personal physicians for their participating entities, the CSSPs being paid in full by both WMPs and the health insurance account according to a predetermined percentage basis split.

8. The method for management of a public health care system of claim 7, wherein the participating entities comprise individual adults and families.

9. The method for management of a public health care system of claim 7, wherein the WMPs are not allowed to decline enrollment requests from the participating entities unless the maximum enrollment cap is reached.

10. The method for management of a public health care system of claim 7, wherein the personal physicians are not allowed to decline enrollment requests from the participating entities unless the maximum enrollment cap is reached.

11. The method for management of a public health care system of claim 7, wherein the WMPs pay about 80±10% of the cost of treatments recommended by the personal physicians and the predetermined percentage basis split of payments to CSSPs by WMPs and the health insurance account is between about 80±20% and about 20±20%, respectively.

12. The method for management of a public health care system of claim 7, wherein the WMPs pay about 80% of the cost of treatments recommended by the personal physicians the predetermined percentage basis split of payments to CSSPs by WMPs and the health insurance account is between about 80% and about 20%, respectively.
